(19) United States
(12) Patent Application Publication
(10) Pub. No.: US 2018/0139733 A1
(43) Pub. Date: May 17, 2018

(54) METHOD FOR TRANSMITTING AND RECEIVING SIGNAL USING WIRELESS FRAME FOR LOW-DELAY COMMUNICATION, AND APPARATUS FOR SAME

(71) Applicant: LG ELECTRONICS INC., Seoul (KR)

(72) Inventors: Hyunsoo Ko, Seoul (KR); Kwangseok Noh, Seoul (KR); Dongkyu Kim, Seoul (KR); Sangrim Lee, Seoul (KR); Hojae Lee, Seoul (KR)

(21) Appl. No.: 15/574,776

(22) PCT Filed: Jun. 8, 2015
(86) PCT No.: PCT/KR2015/005711

§ 371 Date: Nov. 16, 2017

(51) Int. Cl. H04W 72/04; H04L 5/22

(52) U.S. Cl. CPC H04W 72/042; H04W 72/0413; H04W 72/0446; H04L 5/22

(57) ABSTRACT

The present document relates to a wireless frame structure for implementing a low-delay communication in a next generation wireless communication system, and a communication method and apparatus using same. To this end, a terminal receives downlink data from a base station through a data area of a wireless frame, and sends, to the base station, an acknowledgement signal with respect to the downlink data using an uplink control channel area of the wireless frame. Every sub-frame of the wireless frame includes a downlink control channel area and the uplink control channel area, wherein the downlink control channel area is located within a first certain number of symbol areas starting from the start point of the sub-frame, and the uplink control channel area is located within a second certain number of symbol areas starting from the end point of the sub-frame.

### TECHNICAL FIELD

Following description relates to a wireless frame structure for implementing a low-delay communication, a method of performing communication using the wireless frame structure, and an apparatus therefor.

### BACKGROUND ART

FIG. 1 is a diagram for explaining a delay which is occurred when a downlink signal transmission is processed in LTE system.

As shown in FIG. 1, 1 TTI (Transmit Time Interval) has a length of 1 ms in LTE system. If an eNB transmits data to a UE, the data arrives at the UE after time as much as “A” is delayed. The time corresponds to propagation delay in wireless communication.

Having received the data, the UE requires time as much as B, C, D, E, and F for buffering the data, decoding a control channel, decoding the data, preparing a response signal, and transmitting the response signal prior to time corresponding to a trimming advanced.

In general, in LTE system, a delay of 4 ms corresponding to 4 TTI occurs until a confirmation response of a UE is received after data is transmitted from an eNB.

### DISCLOSURE OF THE INVENTION

### Technical Tasks

An object of 5G mobile communication system, which is considered as a following model of the LTE system, is to implement a low-delay communication by reducing the delay to 1 ms or lower.

In case of introducing a massive MIMO system, which is expected to be applied in 5G mobile communication system, it is highly probable that a radio frame of TDD structure is to be used to solve a pilot contamination problem. On the contrary, in case of using a TDD radio frame structure of LTE system, it may be more difficult to satisfy the abovementioned delay reduction condition.

### Technical Solution

To achieve these and other advantages and in accordance with the purpose of the present invention, as embodied and broadly described, according to one embodiment, a method of transceiving a signal, which is transceived by a user equipment (UE) with an eNB in a wireless communication system, includes the steps of receiving a downlink data, by the UE, from the eNB via a data region of a radio frame, and transmitting, by the UE, a confirmation response signal to the eNB using a uplink control channel region of the radio frame in response to the downlink data. In this case, all subframes of the radio frame include a downlink control channel region and the uplink control channel region, the downlink control channel region is positioned within an area of the first prescribed number of symbols from a start point of a subframe, and the uplink control channel region can be positioned within an area of the second prescribed number of symbols from an end point of the subframe.

In this case, the radio frame may correspond to a radio frame used for a TDD scheme.

A subframe of the radio frame can include the data region between the downlink control channel region and the uplink control channel region and the data region can be configured by either a downlink data region or an uplink data region according to a prescribed scheme.

The prescribed scheme can be dynamically configured according to a downlink control signal received via the downlink control channel region. To this end, the downlink control signal can include an indicator indicating whether a data region of a corresponding subframe corresponds to the uplink data region or the downlink data region.

And, the downlink control signal includes information on a subframe in which downlink data is received. If a specific subframe is not indicated as the subframe in which the downlink data is received by the downlink control signal, a data region of the specific subframe can be utilized as the uplink data region.

And, the downlink control signal includes information on a subframe in which uplink data is transmitted. If a specific subframe is not indicated as the subframe in which the uplink data is received by the downlink control signal, a data region of the specific subframe can be utilized as the downlink data region.

If a type of the uplink control channel region indicates a specific type via the downlink control channel region, uplink data transmission or downlink data transmission can be performed via the uplink control channel region.

A subframe of a specific position of the radio frame can be configured to receive a downlink synchronization signal or transmit an uplink synchronization signal via the data region.

It is preferable to configure time between timing of receiving the downlink data and timing of transmitting the confirmation response signal to be 1 ms or less. To this end, each of subframes included in the radio frame may have a length of 0.25 ms.

To further achieve these and other advantages and in accordance with the purpose of the present invention, according to a different embodiment, a user equipment transceiving a signal with an eNB in a wireless communication system includes a transceiver configured to receive a downlink data from the eNB via a data region of a radio frame, the transceiver configured to transmit a confirmation response signal to the eNB using a uplink control channel region of the radio frame in response to the downlink data, and a processor configured to control operations of the transceiver in a manner of being connected with the transceiver. In this case, all subframes of the radio frame include a downlink control channel region and the uplink control channel region, the downlink control channel region is positioned within an area of the first prescribed number of symbols from a start point of a subframe, and the uplink control channel region can be positioned within an area of the second prescribed number of symbols from an end point of the subframe.

### Advantageous Effects

According to the present invention, it is able to implement a low-delay communication in a next generation wireless communication system. In particular, it is able to maintain a low-delay characteristic even when a TDD scheme is applied to implement massive MIMO and the like.

### DESCRIPTION OF DRAWINGS

FIG. 1 is a diagram for explaining a delay which occurs when a downlink signal is transmitted in LTE system;

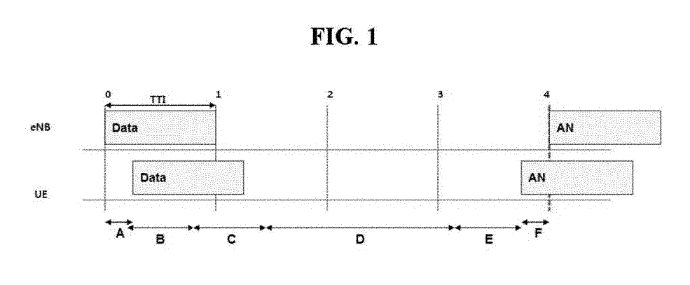

FIG. 2 illustrates an example of a radio frame structure using a normal CP;

FIG. 3 illustrates a different example of a radio frame structure using an extended CP;

FIG. 4 is a diagram for explaining a TDD radio frame structure in LTE system;

FIG. 5 is a diagram for explaining a combination of DL configuration and UL configuration in LTE TDD radio frame structure;

FIG. 6 is a diagram for comparing timings of transmitting a confirmation response in response to downlink data when a FDD frame and a TDD frame are used;

FIG. 7 is a diagram for explaining a delay until a UL data is transmitted after a UL grant is received in FDD and TDD systems;

FIG. 8 is a diagram illustrating a scheme of using a subframe of a short length according to one embodiment of the present invention;

FIG. 9 is a diagram for explaining a radio frame structure which is proposed according to one embodiment of the present invention;

FIG. 10 is a diagram for explaining the embodiment mentioned earlier in FIG. 9 in more detail;

FIG. 11 is a diagram for explaining a procedure of receiving a confirmation response signal in response to DL data transmission according to one embodiment of the present invention;

FIG. 12 illustrates an apparatus for performing the above-described operations.

### BEST MODE

### Mode for Invention

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the invention.

The following detailed description includes specific details in order to provide a thorough understanding of the present invention. However, it will be apparent to those skilled in the art that the present invention may be practiced without such specific details. In some instances, known structures and devices are omitted or are shown in block diagram form, focusing on important features of the structures and devices, so as not to obscure the concept of the present invention.

As mentioned in the foregoing description, following description relates to a radio frame structure for implementing a low-delay communication in a next generation wireless communication system. To this end, first of all, a frame structure of 3GPP wireless communication system to which the present invention is applied is explained in detail.

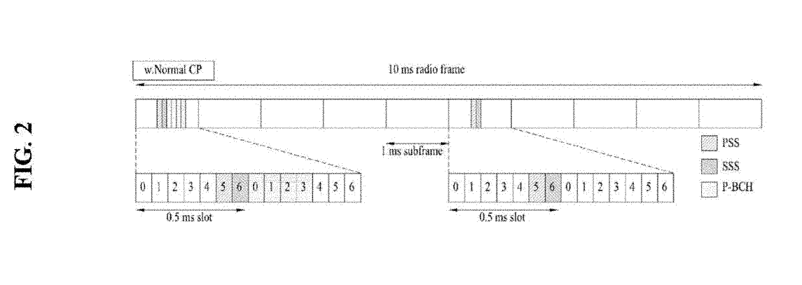

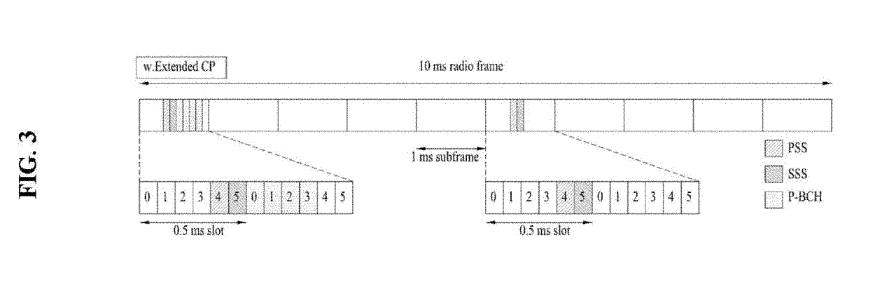

FIGS. 2 and 3 are diagrams for explaining a time domain frame structure in LTE communication system.

Specifically, FIG. 2 illustrates a radio frame structure using a normal CP.

Referring to FIG. 2, a radio frame includes 10 subframes and a subframe includes 2 slots. One slot can include a plurality of OFDM symbols in time domain. The number of OFDM symbols included in a slot can be variously determined according to a CP structure. In a radio frame using a normal CP size, 7 OFDM symbols can be included in a slot. When an OFDM symbol corresponds to 2048 Ts in a radio frame of 10 ms, a size of a normal CP may correspond to 144 Ts (Ts=1/(15000*2048)sec).

P-SCH (primary synchronization channel) is located at the last OFDM symbol of a 0^{th} slot and a 10^{th} slot. The same PSS (primary synchronization signal) is transmitted via two P-SCHs. The P-SCH is used to obtain time domain synchronization such as OFDM symbol synchronization, slot synchronization, and the like and/or frequency domain synchronization. A ZC (Zadoff-Chu) sequence can be used as a PSS. A wireless communication system includes at least one or more PSSs.

S-SCH (secondary synchronization channel) is located at an OFDM symbol immediately before the last OFDM symbol of the 0^{th} symbol and the 10^{th} slot. The S-SCH and the P-SCH may be located at contiguous OFDM symbols. SSSs (secondary synchronization signals) different from each other can be transmitted via two S-SCHs. The S-SCH is used to obtain frame synchronization and/or CP configuration of a cell. In particular, the S-SCH is used to obtain use information of a normal CP or an extended CP. One S-SCH uses two SSSs. An m-sequence can be used as an SSS. In particular, one S-SCH includes two m-sequences. For example, if one S-SCH includes 63 subcarriers, two m-sequences each of which has a length of 31 are mapped to one S-SCH.

The P-SCH and the S-SCH are used to obtain a physical cell ID. The physical cell ID can be represented by 168 physical cell ID groups and 3 physical layer IDs belonging to the groups. In particular, the total number of physical cell IDs corresponds to 504 and can be represented by physical cell ID groups of a range ranging from 1 to 167 and physical layer IDs of a range ranging from 0 to 2. Three ZC sequence root indexes indicating a physical layer ID are used for the P-SCH and 168 m-sequence indexes indicating a physical cell ID group can be used for the S-SCH.

P-BCH (physical-broadcast channel) is located at a 0^{th} subframe in a radio frame. The P-BCH occupies 4 OFDM symbols starting from an 0^{th} OFDM symbol (a symbol appearing after P-SCH) of a 1^{st} slot of the 0^{th} subframe. The P-BCH is used to obtain basic system configuration information of a corresponding eNB. The P-BCH may have a period of 40 ms.

FIG. 3 shows a different example of a radio frame using an extended CP.

Referring to FIG. 3, compared to a radio frame shown in FIG. 2 using a normal CP, when a radio frame uses an extended CP, one slot of the radio frame includes 6 OFDM symbols. When an OFDM symbol corresponds to 2048 Ts in a radio frame of 10 ms, a size of an extended CP may correspond to 512 Ts (Ts=1/(15000*2048)sec).

In a radio frame using an extended CP, P-SCH is located at the last OFDM symbol of a 0^{th} slot and a 10^{th} slot and S-SCH is located at an OFDM symbol immediately before the last OFDM symbol of the 0^{th} slot and the 10^{th} slot. P-BCH is located at a 1^{st} slot of 0^{th} subframe of a radio frame and occupies 4 OFDM symbols starting from a 0^{th} OFDM symbol (a symbol appearing after P-SCH) of the 1^{st} slot of the 0^{th} subframe.

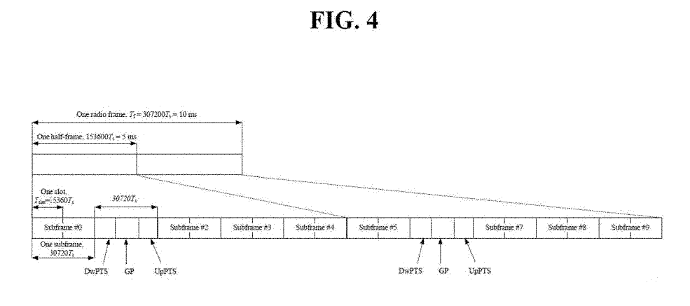

FIG. 4 is a diagram for explaining a TDD radio frame structure in LTE system.

As shown in FIG. 4, a radio frame includes 10 subframes in a TDD radio frame structure. Basically, DL is distinguished from UL in a subframe unit. In case of a special subframe in which DL and UL are efficiently switched, DL can be distinguished from UL in a unit of an OFDM symbol.

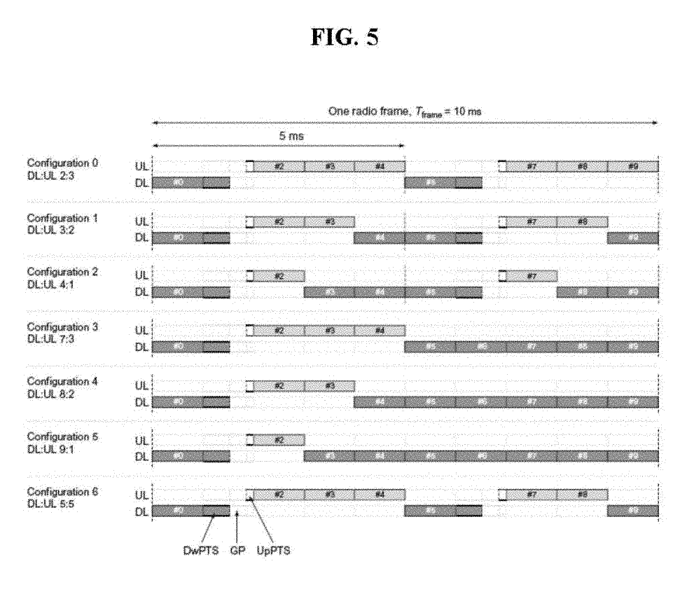

The number of DL subframes and the number of UL subframes can be adaptively changed using a specific combination among a plurality of predetermined combinations. Regarding this, it is explained with reference to FIG. 5 in the following.

FIG. 5 is a diagram for explaining a combination of DL configuration and UL configuration in LTE TDD radio frame structure.

As shown in FIG. 5, a transmission time ratio between DL and UL may selectively use one from among 7 predetermined combinations according to a situation.

FIG. 5 shows a case that a ratio between DL subframes and UL subframes corresponds to DL:UL=(2:3), (3:2), (4:1), (7:3), (8:2), (9:1), and (5:5).

It may be able to perform communication between an eNB and a UE by selecting a combination from among the combinations shown in FIG. 5 according to a traffic status.

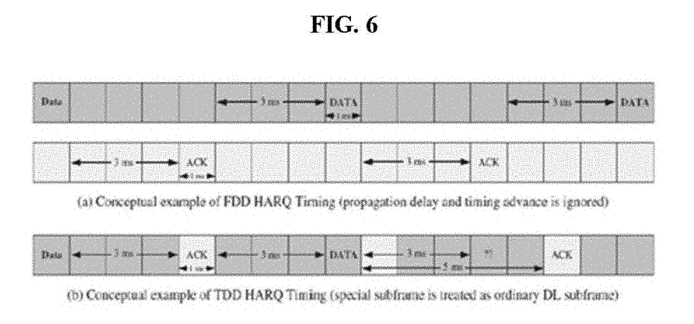

FIG. 6 is a diagram for comparing timings of transmitting a confirmation response in response to downlink data when a FDD frame and a TDD frame are used.

If a transmitting end transmits data in a subframe n, a receiving end receives ACK in a subframe n+k. In case of LTE system, the k corresponds to an integer equal to or greater than 4. If UL signal transmission is available in the subframe n+k, ACK can be transmitted in the subframe n+k. Yet, if UL signal transmission is not available in the subframe n+k, ACK can be transmitted via a subframe in which UL signal transmission is available firstly appearing after the subframe n+k.

In case of LTE FDD system, as mentioned in the foregoing description, a delay as much as 4 ms occurs between the timing at which a signal is transmitted by a transmitting end and the timing at which ACK is received by a receiving end.

Yet, in case of TDD system, as shown in FIG. 6, if a subframe of corresponding timing corresponds to a DL subframe, it is unable to transmit ACK in the DL subframe and the ACK is transmitted via a UL subframe firstly appearing after the DL subframe.

Both UL and DL can be generalized for TDD. In particular, if DL data is transmitted in a subframe, ACK/NACK can be transmitted in a firstly appearing UL subframe after 4 subframes from the subframe. If UL data is transmitted in a subframe, ACK/NACK can be transmitted in a firstly appearing DL subframe after 4 subframes from the subframe. In particular, in case of using a TDD radio frame, ACK/NACK can be received only after minimum 4 ms to maximum 13 ms from the timing at which DL data is transmitted. And, ACK/NACK can be received only after minimum 4 ms to maximum 7 ms from the timing at which UL data is transmitted.

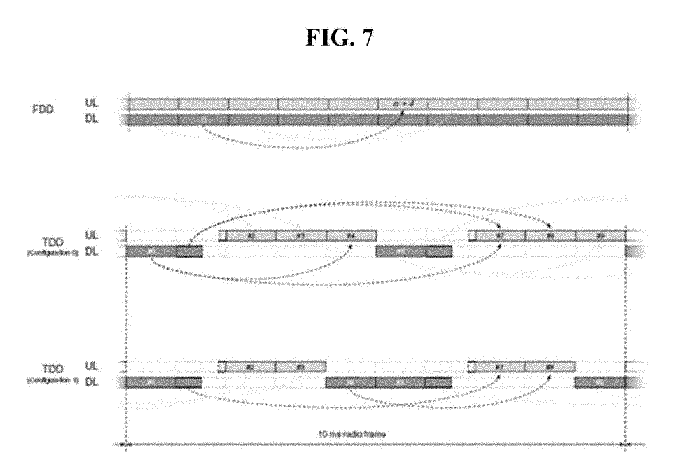

FIG. 7 is a diagram for explaining a delay until a UL data is transmitted after a UL grant is received in FDD and TDD systems.

As shown at the top of FIG. 7, in case of using a FDD radio frame, it may be able to transmit a corresponding UL data in a subframe n+4 after a UL grant is received in a subframe n. On the contrary, in case of using a TDD radio frame, additional delay may occur.

First of all, in case of using TDD configurations 1 to 6 shown in FIG. 5, if a UL grant is received in a subframe n, UL data can be transmitted in a first UL subframe appearing after a subframe n+4. Referring to FIG. 7, when a TDD configuration 1 is used, if a UL grant is received in a subframe #2, UL data is transmitted in a subframe #7 corresponding to a first UL subframe appearing after a subframe #6. If a UL grant is received in a subframe #4, UL data is immediately transmitted in a subframe #8 corresponding to a UL subframe.

Meanwhile, in case of a TDD configuration 0, the number of UL subframes is greater than the number of DL subframes. Hence, it may be able to perform scheduling on a plurality of UL subframes in a single DL subframe. Hence, TDD DL-UL configuration 0 can include an index field indicating a UL subframe related to a UL grant received in a corresponding subframe. In particular, as shown in FIG. 7, if a UL grant is received in a subframe #1, it may indicate either scheduling on a UL subframe #7 or scheduling on a UL subframe #8. Hence, the index field can indicate one of the scheduling.

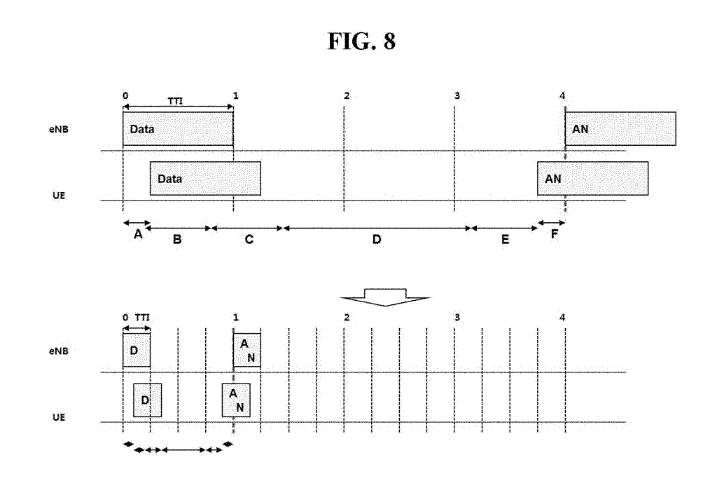

FIG. 8 is a diagram illustrating a scheme of using a subframe of a short length according to one embodiment of the present invention.

As mentioned in the foregoing description, one object of a next generation 5G mobile communication system is to enable low-delay wireless communication by reducing delay time taken for a receiving end to receive a confirmation response signal after a transmitting end transmits data and/or delay time taken for transmitting data after scheduling information is received to 1 ms or less.

As a simplest scheme, it may reduce a structure of TTI to ¼ or less compared to a legacy structure of TTI to reduce delay time of 4 ms to delay time equal to or less than 1 ms.

Yet, although the abovementioned scheme has no special problem for a FDD radio frame, as mentioned in the foregoing description, if a TDD radio frame is used, additional delay may occur depending on a DL-UL configuration. Hence, it is necessary to propose a more fundamental solution.

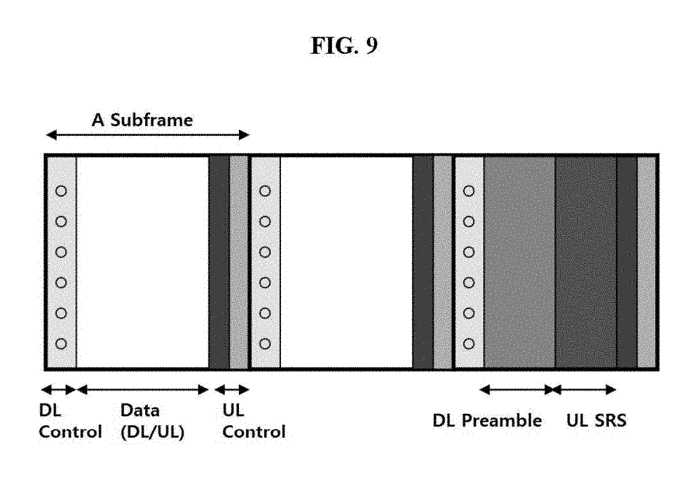

FIG. 9 is a diagram for explaining a radio frame structure which is proposed according to one embodiment of the present invention.

As shown in FIG. 9, one embodiment of the present invention proposes that all subframes are configured to have a DL control region and a UL control region. By doing so, it is not necessary to wait for a UL/DL subframe for transmitting a signal after processing is completed according to a DL-UL configuration in the TDD system.

And, as shown in FIG. 9, the present invention proposes to form a DL control region at an area of the first number of symbols located at the former part of a subframe and form a UL control region at an area of the second number of symbols located at the latter part of the subframe. By doing so, DL/UL scheduling information is received via a DL control signal and then a confirmation response signal can be transmitted in response to the DL/UL scheduling information in the DL control region. Or, it may be able to secure processing time for transmitting and receiving data in the DL control region.

Moreover, it may be able to include a data region between the DL control region and the UL control region. In this case, the data region may correspond to a DL data region or a UL data region. The data region can be dynamically configured according to a traffic status.

According to one preferred embodiment of the present invention, a specific subframe among subframes of the aforementioned radio frame can be configured by a special subframe for transmitting a DL synchronization signal (e.g. DL preamble), a UL synchronization signal (RACH, UL SRS, etc.). Preferably, as mentioned in the foregoing description, it may be able to include a UL control region and a DL control region in the special subframe to prevent unnecessary delay.

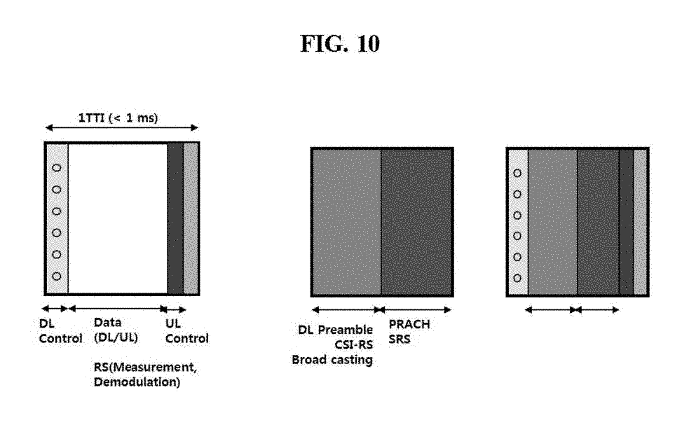

FIG. 10 is a diagram for explaining the embodiment mentioned earlier in FIG. 9 in more detail.

As mentioned in the foregoing description, according to the present embodiment, partial time of a subframe is allocated as a section for transmitting DL control information and a section for transmitting UL control information. The remaining time section is used to transmit data. DL or UL transmission can be performed in a data region.

A DL control channel can include an indicator indicating DL data reception and UL data transmission, A/N report on UL data transmission, and the like.

A UL control section can be used for performing a scheduling request and A/N reporting. It may also consider a periodically transmitted SRS and an SRS transmitted by triggering.

A section for transmitting a UL control channel may become time appearing after data is transmitted. This is intended to perform UL transmission after time for decoding data is sufficiently secured. For example, if A/N is transmitted in a UL control channel of a next subframe after DL is received, it may be able to secure time as much as 1 TTI as time for performing decoding and UL transmission.

A UL control region is secured by a partial time section of a subframe. When a dedicated time zone for a control signal is allocated to the partial time section, as a method of reducing data transmission loss, a DL control section can indicate whether or not data transmission is available in the dedicated time zone. This is because, since an eNB knows A/N reporting time for DL transmission, the eNB is able to determine whether or not the region is available. For example, the eNB can indicate whether or not the UL control region is used for a different usage using a specific indicator of a DCI format.

It may be able to transmit a reference signal in a section in which data is transmitted. The reference signal can be categorized into a measurement RS for measuring a channel and a DMRS for transmitting data.

Moreover, as mentioned in the foregoing description, a special subframe shown at the center of FIG. 10 can be allocated by a time section for transmitting synchronization signal and system information. The time section can be configured to transmit a DL synchronization signal and a UL synchronization signal (e.g. PSS/SSS, PRACH). And, the special subframe can also be configured to transmit a reference signal for measuring a channel. A channel for transmitting system information can be assigned to the subframe.

Preferably, as shown at the right side of FIG. 10, in order to forward control information related to data transmission, a special subframe can also include a DL control channel and a UL control channel.

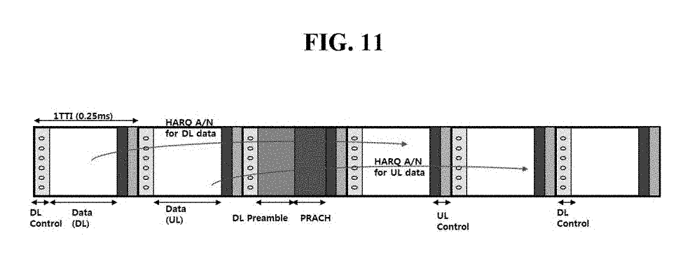

FIG. 11 is a diagram for explaining a procedure of receiving a confirmation response signal in response to DL data transmission according to one embodiment of the present invention.

Referring to FIG. 11, about 0.25 ms is configured as a transmission time section, by which the present invention may be non-limited. The transmission time section can be changed by various values.

In case of receiving a DL data demodulation indicator via a DL control channel, data decoding is performed in a corresponding subframe. Subsequently, A/N is reported via a UL control channel defined in the subframe after k subframes.

Referring to FIG. 11, A/N is transmitted via a UL control channel included in a subframe appearing after 3 subframes. In this case, it is able to see that 1 ms OTA (over the air) delay condition is satisfied until data is transmitted and A/N is received.

If UL data is transmitted, a UE is able to recognize A/N in a DL control channel region of a corresponding subframe after k+1 subframe.

If a DL control channel region is excluded from a data transmission subframe, time between data transmission and A/N feedback satisfies 1 ms OTA.

A DL/UL synchronization section can be periodically configured according to a necessity or can be designated in a manner of being transmitted in a specific subframe. A DL/UL control channel region can be defined to permit DL and UL A/N feedback to be received in a subframe section in which a signal for UL/DL synchronization is transmitted or received.

Meanwhile, a method of indicating whether a data transmission section corresponds to DL or UL is described in the following.

As mentioned in the foregoing description, a section in which a DL control signal, a UL control signal, or a synchronization signal is transmitted corresponds to a time section dedicated to DL or UL. On the contrary, a data region is defined to flexibly use DL or UL.

Under the abovementioned assumption, according to one embodiment, a DL/UL subframe indicator is configured within a DL control channel section. In particular, a DL/UL subframe indicator of a DL control channel can indicate whether a data region of a subframe is used for DL or UL.

Meanwhile, according to a different embodiment, it may be able to configure a grant message included in a DL control channel to recognize a time section capable of receiving a DL data or a time section capable of transmitting a UL data.

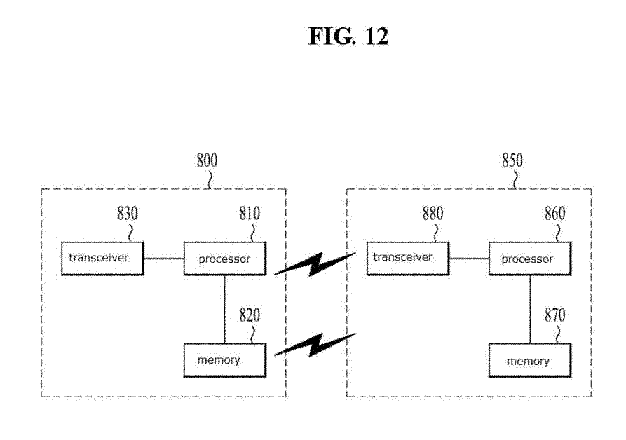

FIG. 12 illustrates an apparatus for performing the above-described operations.

A radio apparatus 800 shown in FIG. 12 may correspond to the aforementioned UE installed in a specific vehicle as described above and a radio apparatus 850 may correspond to the aforementioned eNB.

The UE may include a processor 810, a memory 820 and a transceiver 830 and the eNB 850 may include a processor 860, a memory 870 and a transceiver 880. The transceivers 830 and 880 transmit/receive radio signals and may be executed in the physical layer of 3GPP and the like. The processor 810/860 is executed in a physical layer and/or a MAC layer and is connected with the transceiver 830/880. The processor 810/860 can perform the aforementioned interference control procedure.

The processors 810 and 860 and/or the transceivers 830 and 880 may include a specific application-specific integrated circuit (ASIC), another chipset, a logic circuit and/or a data processor. The memories 820 and 870 may include a ROM (Read-Only Memory), a RAM (Random Access Memory), a flash memory, a memory card, a storage medium and/or another storage unit. When an embodiment is executed by software, the aforementioned methods may be executed as modules (e.g., processors or functions) which execute the aforementioned functions. The modules may be stored in the memories 820 and 870 and executed by the processors 810 and 860. The memories 820 and 870 may be provided to the inside or outside of the processors 810 and 860 or connected to the processors 810 and 860 through a known means.

As described above, the detailed description of the preferred embodiments of the present invention has been given to enable those skilled in the art to implement and practice the invention. Although the invention has been described with reference to exemplary embodiments, those skilled in the art will appreciate that various modifications and variations can be made in the present invention without departing from the spirit or scope of the invention described in the appended claims.

### INDUSTRIAL APPLICABILITY

As mentioned in the foregoing description, the present invention can be applied to various wireless systems pursuing a low-delay wireless communication.

What is claimed is:

1. A method of transceiving a signal, which is transceived by a user equipment (UE) with an eNB in a wireless communication system, the method comprising:
receiving a downlink data, by the UE, from the eNB via a data region of a radio frame; and
transmitting, by the UE, a confirmation response signal to the eNB using a uplink control channel region of the radio frame in response to the downlink data,
wherein all subframes of the radio frame comprise a downlink control channel region and the uplink control channel region,
wherein the downlink control channel region is positioned within an area of the first prescribed number of symbols from a start point of a subframe, and
wherein the uplink control channel region is positioned within an area of the second prescribed number of symbols from an end point of the subframe.

2. The method of claim 1, wherein the radio frame is a radio frame used for a TDD scheme.

3. The method of claim 1, wherein a subframe of the radio frame comprises the data region between the downlink control channel region and the uplink control channel region and
wherein the data region is configured by either a downlink data region or an uplink data region according to a prescribed scheme.

4. The method of claim 3, wherein the prescribed scheme is dynamically configured according to a downlink control signal received via the downlink control channel region.

5. The method of claim 4, wherein the downlink control signal comprises an indicator indicating whether a data region of a corresponding subframe corresponds to the uplink data region or the downlink data region.

6. The method of claim 4, wherein the downlink control signal comprises information on a subframe in which downlink data is received and
wherein if a specific subframe is not indicated as the subframe in which the downlink data is received by the downlink control signal, a data region of the specific subframe is utilized as the uplink data region.

7. The method of claim 4, wherein the downlink control signal comprises information on a subframe in which uplink data is transmitted and
wherein if a specific subframe is not indicated as the subframe in which the uplink data is received by the downlink control signal, a data region of the specific subframe is utilized as the downlink data region.

8. The method of claim 1, wherein if a type of the uplink control channel region indicates a specific type via the downlink control channel region, uplink data transmission or downlink data transmission is performed via the uplink control channel region.

9. The method of claim 1, wherein a subframe of a specific position of the radio frame is configured to receive a downlink synchronization signal or transmit an uplink synchronization signal via the data region.

10. The method of claim 1, wherein time between timing of receiving the downlink data and timing of transmitting the confirmation response signal is configured to be 1 ms or less.

11. The method of claim 10, wherein each of subframes contained in the radio frame has a length of 0.25 ms.

12. A user equipment transceiving a signal with an eNB in a wireless communication system, the user equipment comprising:
a transceiver configured to receive a downlink data from the eNB via a data region of a radio frame, the transceiver configured to transmit a confirmation response signal to the eNB using a uplink control channel region of the radio frame in response to the downlink data; and
a processor configured to control operations of the transceiver in a manner of being connected with the transceiver,
wherein all subframes of the radio frame comprise a downlink control channel region and the uplink control channel region,
wherein the downlink control channel region is positioned within an area of the first prescribed number of symbols from a start point of a subframe, and
wherein the uplink control channel region is positioned within an area of the second prescribed number of symbols from an end point of the subframe.
